(19) United States
(12) Patent Application Publication
(10) Pub. No.: US 2025/0247174 A1
(43) Pub. Date: Jul. 31, 2025

(54) CONFIGURE RETRANSMISSION PARAMETERS

(71) Applicant: QUALCOMM INCORPORATED, San Diego, CA (US)

(72) Inventors: Idan Michael Horn, Hod Hasharon (IL); Shay Landis, Hod Hasharon (IL); Amit Bar-Or Tillinger, Tel-Aviv (IL)

(21) Appl. No.: 18/866,919

(22) PCT Filed: Jun. 16, 2023
(86) PCT No.: PCT/US2023/025594

§ 371 Date: Nov. 18, 2024

(30) Foreign Application Priority Data
Jul. 13, 2022 (IL) 294737

(51) Int. Cl. H04L 1/1829; H04W 72/21; H04W 72/232

(52) U.S. Cl. CPC H04L 1/1858; H04W 72/21; H04W 72/232

(57) ABSTRACT

Methods, systems, and devices for wireless communications are described. A user equipment (UE) may receive a control message that includes one or more control parameters associated with retransmissions for feedback messages during a connection establishment procedure, the control parameters including an indication of a resource used for the retransmissions. The UE may transmit a feedback message associated with a first transmission. The UE may receive a retransmission associated with the transmission based on the control parameters from the control message. In some implementations, the UE may also receive a DCI message with a reduced payload (e.g., a payload that excludes the control parameters).

### CROSS REFERENCE

The present application is a 371 national stage filing of International PCT Application No. PCT/US2023/025594 by HORN et al. entitled “CONFIGURE RETRANSMISSION PARAMETERS,” filed Jun. 16, 2023; and claims priority to Israel Patent Application No. 294737 by HORN et al. entitled “CONFIGURE RETRANSMISSION PARAMETERS,” filed Jul. 13, 2022, each of which is assigned to the assignee hereof, and each of which is expressly incorporated by reference in its entirety herein.

### FIELD OF TECHNOLOGY

The following relates to wireless communications, including configure retransmission parameters.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques generally relate to improved methods, systems, devices, and apparatuses that support configuring retransmission parameters. For example, a user equipment (UE) may receive a control message that includes one or more control parameters associated with retransmissions for feedback messages. In some cases, the UE may receive the control message during a connection establishment procedure. The UE may receive (or fail to receive) a transmission and transmit a feedback message associated with the first transmission. The UE may then receive a retransmission associated with the transmission based on the control parameters from the control message. In some implementations, the UE may also receive a DCI message with a reduced payload (e.g., a payload that excludes the control parameters) or may receive a DCI message that includes the control parameters and determine to ignore the DCI control parameters in favor of the control message control parameters. In some examples, the control parameters may include indications of a resource (e.g., a frequency resource or a time resource), a sampling rate, of whether a hopping pattern is enabled, a redundancy version, frequency allocation, a modulation and coding scheme (MCS), or any combination thereof. In some cases, the indications may be in the form of a ratio, a difference, or both, between the transmission and the retransmission.

A method for wireless communication at a UE is described. The method may include receiving a control message including a control parameter associated with retransmissions for feedback messages, where the control parameter includes an indication of a resource used for the retransmissions, receiving a first transmission associated with an instance of the feedback messages indicated by the control message, transmitting a feedback message for the first transmission based on receiving the first transmission, and receiving a first retransmission associated with the feedback messages of the first transmission based on transmitting the feedback message and the control parameter associated with the retransmissions.

An apparatus for wireless communication at a UE is described. The apparatus may include a processor, memory coupled with the processor, and instructions stored in the memory. The instructions may be executable by the processor to cause the apparatus to receive a control message including a control parameter associated with retransmissions for feedback messages, where the control parameter includes an indication of a resource used for the retransmissions, receive a first transmission associated with an instance of the feedback messages indicated by the control message, transmit a feedback message for the first transmission based on receiving the first transmission, and receive a first retransmission associated with the feedback messages of the first transmission based on transmitting the feedback message and the control parameter associated with the retransmissions.

Another apparatus for wireless communication at a UE is described. The apparatus may include means for receiving a control message including a control parameter associated with retransmissions for feedback messages, where the control parameter includes an indication of a resource used for the retransmissions, means for receiving a first transmission associated with an instance of the feedback messages indicated by the control message, means for transmitting a feedback message for the first transmission based on receiving the first transmission, and means for receiving a first retransmission associated with the feedback messages of the first transmission based on transmitting the feedback message and the control parameter associated with the retransmissions.

A non-transitory computer-readable medium storing code for wireless communication at a UE is described. The code may include instructions executable by a processor to receive a control message including a control parameter associated with retransmissions for feedback messages, where the control parameter includes an indication of a resource used for the retransmissions, receive a first transmission associated with an instance of the feedback messages indicated by the control message, transmit a feedback message for the first transmission based on receiving the first transmission, and receive a first retransmission associated with the feedback messages of the first transmission based on transmitting the feedback message and the control parameter associated with the retransmissions.

Some examples of the method, apparatuses, and non-transitory computer-readable medium described herein may further include operations, features, means, or instructions for receiving a DCI message associated with the first retransmission, the DCI message including a second control parameter and determining to use the control parameter from the control message and ignore the second control parameter from the DCI message based on receiving the DCI message, where the resource indicated in the control parameter may be different than a second resource indicated in the second control parameter.

Some examples of the method, apparatuses, and non-transitory computer-readable medium described herein may further include operations, features, means, or instructions for receiving a DCI message associated with the first retransmission and adjusting a sampling rate associated with the first retransmission based on the DCI message being associated with the first retransmission, where receiving the first retransmission may be further based on adjusting the sampling rate.

Some examples of the method, apparatuses, and non-transitory computer-readable medium described herein may further include operations, features, means, or instructions for transmitting a message indicating one or more preferred control parameters for the retransmissions, where the control parameter may be based on the one or more preferred control parameters.

In some examples of the method, apparatuses, and non-transitory computer-readable medium described herein, receiving the control message may include operations, features, means, or instructions for receiving the control message that includes a set of multiple control parameters for the retransmissions, where the set of multiple control parameters includes the control parameter.

Some examples of the method, apparatuses, and non-transitory computer-readable medium described herein may further include operations, features, means, or instructions for determining a second control parameter of the set of multiple control parameters including an indication of whether a hopping pattern may be enabled for the retransmissions, a third control parameter of the set of multiple control parameters including an indication of a redundancy version for the retransmissions, a fourth control parameter of the set of multiple control parameters including an indication of frequency allocation used for the retransmissions, a fifth control parameter of the set of multiple control parameters including an indication of a MCS used for the retransmissions, or any combination thereof, where receiving the first retransmission may be based on the determining.

In some examples of the method, apparatuses, and non-transitory computer-readable medium described herein, each indication of the set of multiple control parameters include a ratio, a difference, or both, between the first transmission and the retransmissions.

Some examples of the method, apparatuses, and non-transitory computer-readable medium described herein may further include operations, features, means, or instructions for receiving a DCI message associated with the first retransmission, where the DCI message excludes the control parameter.

Some examples of the method, apparatuses, and non-transitory computer-readable medium described herein may further include operations, features, means, or instructions for transmitting an UCI message associated with the first retransmission, where the UCI message excludes the control parameter.

Some examples of the method, apparatuses, and non-transitory computer-readable medium described herein may further include operations, features, means, or instructions for transmitting an UCI message associated with the first retransmission, the UCI message including a second control parameter and determining to use the control parameter from the control message and ignore the second control parameter from the UCI message, where the resource indicated in the control parameter may be different than a frequency resource indicated in the second control parameter.

Some examples of the method, apparatuses, and non-transitory computer-readable medium described herein may further include operations, features, means, or instructions for determining a time resource and a frequency resource used for the retransmissions based on the control parameter, where receiving the first retransmission may be based on determining the time resource and the frequency resource.

Some examples of the method, apparatuses, and non-transitory computer-readable medium described herein may further include operations, features, means, or instructions for receiving a second control message including an updated control parameter associated with the retransmissions for the feedback messages, where the second control message includes a radio resource control (RRC) message or a medium access control-control element message (MAC-CE).

In some examples of the method, apparatuses, and non-transitory computer-readable medium described herein, the control message includes a RRC message may be received as part of a connection establishment procedure.

In some examples of the method, apparatuses, and non-transitory computer-readable medium described herein, the feedback messages may be associated with hybrid automatic repeat request (HARQ) feedback and the first retransmission may be a downlink retransmission.

A method for wireless communication at a network entity is described. The method may include outputting a control message including a control parameter associated with retransmissions for feedback messages, where the control parameter includes an indication of a resource used for the retransmissions, outputting a first transmission associated with an instance of the feedback messages indicated by the control message, obtaining a feedback message for the first transmission based on outputting the first transmission, and outputting a first retransmission associated with the feedback messages of the first transmission based on obtaining the feedback message and the control parameter associated with the retransmissions.

An apparatus for wireless communication at a network entity is described. The apparatus may include a processor, memory coupled with the processor, and instructions stored in the memory. The instructions may be executable by the processor to cause the apparatus to output a control message including a control parameter associated with retransmissions for feedback messages, where the control parameter includes an indication of a resource used for the retransmissions, output a first transmission associated with an instance of the feedback messages indicated by the control message, obtain a feedback message for the first transmission based on outputting the first transmission, and output a first retransmission associated with the feedback messages of the first transmission based on obtaining the feedback message and the control parameter associated with the retransmissions.

Another apparatus for wireless communication at a network entity is described. The apparatus may include means for outputting a control message including a control parameter associated with retransmissions for feedback messages, where the control parameter includes an indication of a resource used for the retransmissions, means for outputting a first transmission associated with an instance of the feedback messages indicated by the control message, means for obtaining a feedback message for the first transmission based on outputting the first transmission, and means for outputting a first retransmission associated with the feedback messages of the first transmission based on obtaining the feedback message and the control parameter associated with the retransmissions.

A non-transitory computer-readable medium storing code for wireless communication at a network entity is described. The code may include instructions executable by a processor to output a control message including a control parameter associated with retransmissions for feedback messages, where the control parameter includes an indication of a resource used for the retransmissions, output a first transmission associated with an instance of the feedback messages indicated by the control message, obtain a feedback message for the first transmission based on outputting the first transmission, and output a first retransmission associated with the feedback messages of the first transmission based on obtaining the feedback message and the control parameter associated with the retransmissions.

Some examples of the method, apparatuses, and non-transitory computer-readable medium described herein may further include operations, features, means, or instructions for outputting a DCI message associated with the first retransmission, the DCI message including a second control parameter, where the resource indicated in the control parameter may be different than a second resource indicated in the second control parameter.

Some examples of the method, apparatuses, and non-transitory computer-readable medium described herein may further include operations, features, means, or instructions for outputting a DCI message associated with the first retransmission for adjusting a sampling rate associated with the first retransmission based on the DCI message being associated with the first retransmission, where outputting the first retransmission may be further based on the adjusted sampling rate.

Some examples of the method, apparatuses, and non-transitory computer-readable medium described herein may further include operations, features, means, or instructions for obtaining a message indicating one or more preferred control parameters for the retransmissions, where the control parameter may be based on the one or more preferred control parameters.

In some examples of the method, apparatuses, and non-transitory computer-readable medium described herein, outputting the control message may include operations, features, means, or instructions for outputting the control message that includes a set of multiple control parameters for the retransmissions, where the set of multiple control parameters includes the control parameter.

Some examples of the method, apparatuses, and non-transitory computer-readable medium described herein may further include operations, features, means, or instructions for determining a second control parameter of the set of multiple control parameters including an indication of whether a hopping pattern may be enabled for the retransmissions, a third control parameter of the set of multiple control parameters including an indication of a redundancy version for the retransmissions, a fourth control parameter of the set of multiple control parameters including an indication of frequency allocation used for the retransmissions, a fifth control parameter of the set of multiple control parameters including an indication of a MCS used for the retransmissions, or any combination thereof, where receiving the first retransmission may be based on the determining.

In some examples of the method, apparatuses, and non-transitory computer-readable medium described herein, each indication of the set of multiple control parameters include a ratio, a difference, or both, between the first transmission and the retransmissions.

Some examples of the method, apparatuses, and non-transitory computer-readable medium described herein may further include operations, features, means, or instructions for outputting a DCI message associated with the first retransmission, where the DCI message excludes the control parameter.

Some examples of the method, apparatuses, and non-transitory computer-readable medium described herein may further include operations, features, means, or instructions for obtaining an UCI message associated with the first retransmission, where the UCI message excludes the control parameter.

Some examples of the method, apparatuses, and non-transitory computer-readable medium described herein may further include operations, features, means, or instructions for obtaining an UCI message associated with the first retransmission, the UCI message including a second control parameter, where the resource indicated in the control parameter may be different than a frequency resource indicated in the second control parameter.

Some examples of the method, apparatuses, and non-transitory computer-readable medium described herein may further include operations, features, means, or instructions for determining a time resource and a frequency resource used for the retransmissions based on the control parameter, where receiving the first retransmission may be based on determining the time resource and the frequency resource.

Some examples of the method, apparatuses, and non-transitory computer-readable medium described herein may further include operations, features, means, or instructions for outputting a second control message including an updated control parameter associated with the retransmissions for the feedback messages, where the second control message includes a RRC message or a MAC-CE message.

In some examples of the method, apparatuses, and non-transitory computer-readable medium described herein, the control message may be outputted as part of a connection establishment procedure.

In some examples of the method, apparatuses, and non-transitory computer-readable medium described herein, the feedback messages may be associated with HARQ feedback and the first retransmission may be a downlink retransmission.

### BRIEF DESCRIPTION OF THE DRAWINGS

FIG. 1 illustrates an example of a wireless communications system that supports configure retransmission parameters in accordance with one or more aspects of the present disclosure.

FIG. 2 illustrates an example of a wireless communications system that supports configure retransmission parameters in accordance with one or more aspects of the present disclosure.

FIG. 3 illustrates an example of a process flow that supports configure retransmission parameters in accordance with one or more aspects of the present disclosure.

FIGS. 4 and 5 show block diagrams of devices that support configure retransmission parameters in accordance with one or more aspects of the present disclosure.

FIG. 6 shows a block diagram of a communications manager that supports configure retransmission parameters in accordance with one or more aspects of the present disclosure.

FIG. 7 shows a diagram of a system including a device that supports configure retransmission parameters in accordance with one or more aspects of the present disclosure.

FIGS. 8 and 9 show block diagrams of devices that support configure retransmission parameters in accordance with one or more aspects of the present disclosure.

FIG. 10 shows a block diagram of a communications manager that supports configure retransmission parameters in accordance with one or more aspects of the present disclosure.

FIG. 11 shows a diagram of a system including a device that supports configure retransmission parameters in accordance with one or more aspects of the present disclosure.

FIGS. 12 through 15 show flowcharts illustrating methods that support configure retransmission parameters in accordance with one or more aspects of the present disclosure.

### DETAILED DESCRIPTION

In some wireless communications systems, wireless devices may support retransmission procedures for hybrid automatic repeat request (HARQ) feedback. For example, a user equipment (UE) may transmit a negative acknowledgment (NACK) message associated with a failed transmission. A network entity may configure the UE to receive a retransmission of the failed transmission by outputting a dedicated downlink control information (DCI) message. The DCI message may indicate multiple control parameters for receiving the retransmission via a physical downlink shared channel (PDSCH). In some cases, the network entity may configure the UE with a DCI message before every retransmission. However, a payload of the DCI message that includes the multiple control parameters for every retransmission may inefficiently utilize resources and consume a relatively high amount of power. For example, a subset of the multiple control parameters may remain the same or may be similar between different transmissions such that a second indication of the subset may be redundant. In some examples, a retransmission may be smaller (e.g., utilize less resources) than a first transmission and may not utilize all of an allocated bandwidth such that the UE may inefficiently consume a larger amount of power to process the entire bandwidth that includes a portion of unutilized resources. To reduce power consumption, among other benefits, the retransmission procedure for HARQ feedback may be updated.

A method for wireless communication is described. The method may include techniques for configuring retransmission parameters via a control message (e.g., a radio resource control (RRC) message). For example, a UE may receive the control message that includes one or more control parameters associated with retransmissions for feedback messages. In some cases, the UE may receive the control message during a connection establishment procedure. The UE may receive (or fail to receive) a transmission and transmit a feedback message associated with the first transmission. The UE may then receive a retransmission associated with the transmission based on the control parameters indicated in the control message (e.g., an RRC message). In some implementations, the UE may also receive a DCI message (in response to transmitting the feedback message) with a reduced payload (e.g., a payload that excludes the control parameters) or may receive a DCI message that includes the control parameters and determine to ignore the DCI control parameters in favor of the control message control parameters. In some examples, the control parameters may include indications of a resource (e.g., a frequency resource or a time resource), a sampling rate, of whether a hopping pattern is enabled, a redundancy version, frequency allocation, a modulation and coding scheme (MCS), or any combination thereof. In some cases, the indications may be in the form of a ratio, a difference, or both, between the transmission and the retransmission.

Aspects of the disclosure are initially described in the context of wireless communications systems. Aspects of the disclosure are further illustrated by and described with reference to a process flow diagram, apparatus diagrams, system diagrams, and flowcharts that relate to configure retransmission parameters.

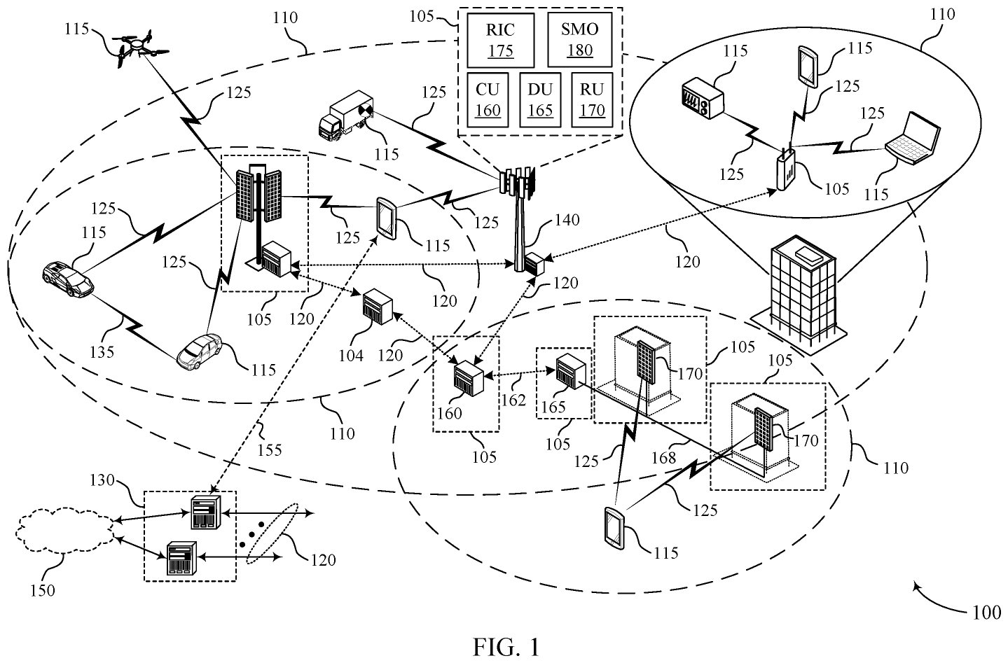

FIG. 1 illustrates an example of a wireless communications system 100 that supports configure retransmission parameters in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support configure retransmission parameters as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. HARQ feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval. In some cases, HARQ may be considered as a spectral efficient method to increase link throughput (e.g., throughput at the communication link 125, the D2D communication link 135). A HARQ retransmission may provide for both coding gain and repetition gain (e.g., greater than three decibel gain) by carrying various coded bits (e.g., different redundancy versions).

In some examples of wireless communications systems 100 that support 5G-NR, a UE 115 may consume a relatively large amount of power. As wireless communications expand (e.g., grow into bands such as frequency four, frequency five, sixth generation, etc.) power consumption may increase due to supporting relatively higher bandwidth signals and relatively higher data rates (e.g., higher than 5G), and may provide various challenges with supporting the increase in power consumption. In some cases, the power consumption may come from various power consumers, such as antenna elements, processing of analog-to-digital converters (ADCs), processing of digital-front-end (DFE), and digital baseband processing, among other examples.

In some examples, as part of a retransmission procedure for HARQ feedback, a UE 115 may inefficiently utilize resources and consume a relatively large amount of power. For example, the UE 115 may transmit a NACK message associated with a failed transmission. A network entity 105 may configure the UE 115 to receive a retransmission of the failed transmission by outputting a dedicated DCI message. The DCI message may indicate multiple control parameters for receiving the retransmission via a PDSCH. In some cases, the network entity 105 may configure the UE 115 with a DCI message before every retransmission. However, a payload of the DCI message that includes the multiple control parameters for every retransmission may inefficiently utilize resources and consume a relatively high amount of power. For example, some code block groups associated with the transmission and a HARQ process may succeed (pass) the CRC check. Therefore, a retransmission for those code block groups may be redundant and a payload associated with a retransmission may be decreased. For code block groups that fail CRC, in some cases, the code block groups may have instead passed CRC if the code block groups had relatively small (e.g., smaller than two decibels) signal to interference plus noise ratio (SINR) gain, such that a high gain (e.g., three decibels) may inefficiently utilize resources and a higher coding rate may be applied to the retransmission. In some examples, a downlink channel associated with the retransmission may be smaller (e.g., utilize less resources) than a first transmission and may not utilize (e.g., may not fill) all of an allocated bandwidth or bandwidth group such that the UE 115 may inefficiently consume (waste) a large amount of power to support the bandwidth that includes a portion of unutilized resources. To reduce power consumption (e.g., dynamically reconfigure power consumers according to bandwidth and bandwidth group configurations), decrease a payload associated with a retransmission, increase coding rate and utilize smaller gain, and the like, the retransmission procedure for HARQ feedback may be updated.

Techniques are described for a retransmission procedure for HARQ feedback that includes configuring retransmissions via a control message (e.g., an RRC message), which may result in reducing a retransmission payload overhead (e.g., associated with physical downlink control channel (PDCCH)) and power consumption of a UE 115. For example, a UE 115 may receive the control message (e.g., an RRC message) that includes one or more control parameters associated with retransmissions for feedback messages. The control parameters may include parameters such as coding rate, frequency allocation, and the like. In some cases, the UE 115 may receive the control message during a connection establishment procedure. The UE 115 may receive (or fail to receive) a transmission and transmit a feedback message associated with the first transmission. The UE 115 may then receive a retransmission associated with the transmission based on the control parameters indicated in the control message. In some implementations, the UE 115 may also receive a DCI message with a reduced payload (e.g., a payload that excludes the control parameters) or may receive a DCI message that includes the control parameters and determine to ignore the DCI control parameters in favor of the control message control parameters.

In some cases, power consumption associated with a UE 115 may be reduced. For example, the UE 115 may be configured with control parameters that indicate a frequency allocation and a bandwidth group of retransmission such that the UE 115 may reconfigure the DFE and digital components according to the control parameters. In some examples, the UE 115 may be configured with a 2 GHz bandwidth where half of the bandwidth is allocated to a PDSCH retransmission. In a case where the UE 115 receives configuration information associated with a bandwidth group of a retransmission (e.g., an RRC message including a control parameter indicating bandwidth), the UE 115 may reduce a total power consumption by fifteen percent (e.g., excluding calculations associated with power and payload saved in the control channel) when compared to a case where the UE 115 does not receive configuration information associated with the bandwidth group of the retransmission. For example, the total power consumption may be reduced by reducing power at a modem (via fast Fourier transform (FFT) power reduction), a web map service (WMS) (via filter power reduction), and radio frequency (via ADC power reduction).

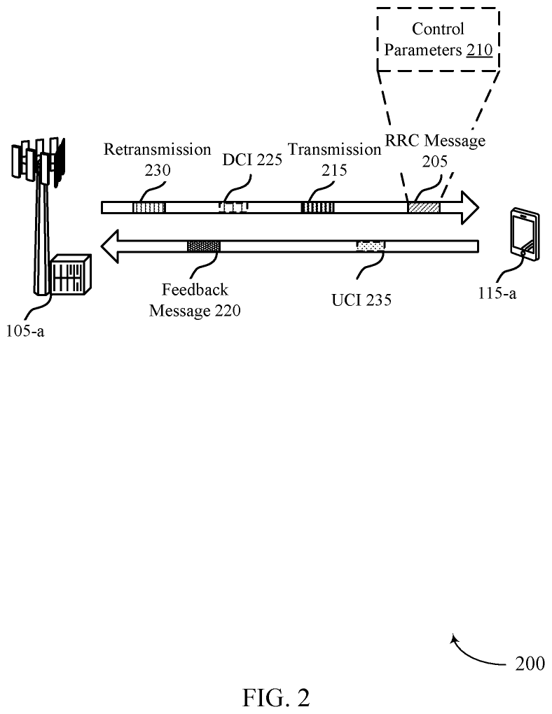

FIG. 2 illustrates an example of a wireless communications system 200 that supports configure retransmission parameters in accordance with one or more aspects of the present disclosure. In some examples, the wireless communications system 200 may implement aspects of the wireless communications system 100. For example, the wireless communications system 200 may include a network entity 105-a and a UE 115-a, which may be examples of a network entity 105 and a UE 115 respectively, as described herein with reference to FIG. 1. The network entity 105-a and the UE 115-a may be in wireless communication.

In some cases, the network entity 105-a may configure the UE 115-a for a retransmission. For example, the network entity 105-a may output a transmission 215. The network entity 105-a may then output a DCI 225 to configure the UE 115-a to receive a retransmission 230 associated with the transmission 215. In some cases, the DCI 225 may be a dedicated DCI for the retransmission 230 that includes indications of multiple control parameters to configure the PDSCH for the retransmission 230. In some cases, the network entity 105-a may output multiple transmissions 215 and may output a distinct DCI 225 for each of the multiple transmissions 215. However, outputting a distinct DCI 225 for each of the multiple transmissions 215 that indicate same or similar control parameters may result in inefficient utilization of resources and a relatively high amount of power consumption. Additionally, or alternatively, the retransmission 230 may utilize less resources than configured (e.g., less resources than the transmission 215). For example, the retransmission 230 may utilize a portion of a bandwidth or a bandwidth group associated with the transmission 215. However, because the bandwidth is defined, the UE 115-a may process the entire bandwidth and disregard (discard) information associated with portions of the bandwidth unassociated with the retransmission 230, which may result in inefficient utilization of resources and a relatively high amount of power consumption.

In some cases, to reduce power consumption, control payload, or both, among others, the UE 115 may determine configurations (e.g., control parameters 210) associated with one or more retransmissions (e.g., retransmission 230) before receiving the associated transmission (e.g., transmission 215). For example, a network entity 105-a may output a control message including one or more control parameters 210 associated with retransmissions 230 (e.g., a downlink retransmission). In some implementations, the control message may be an RRC message 205, or another control message (e.g., MAC control element (CE)), where the control message is part of a connection establishment procedure and the feedback message pertains to a HARQ process. The UE 115-a may determine control parameters 210 from the RRC message 205, where the control parameters 210 include various indications to configure the UE 115-a for the retransmissions 230. The network entity 105-a may then output a transmission 215 and obtain a feedback message 220 indicating whether the UE 115-a successfully processed the transmission 215. On a failure (e.g., the feedback message 220 indicating a NACK), the network entity 105-a may output a retransmission 230 associated with the transmission 215. The UE 115-a may receive the retransmission 230 based on the control parameters 210. In some cases, the network entity 105-a and the UE 115-a may repeat a similar process for a second transmission 215 and a second retransmission 230 in which the UE 115-a may receive the second retransmission 230 based on the same control parameters 210 (e.g., rather than based on control parameters from a distinct DCI 225).

In some examples, some retransmissions 230 associated with the HARQ process may utilize similar control parameters 210 as those used for the transmissions 215. For example, because the control parameters 210 are similar (e.g., the same, within a range of error, below an error threshold, etc.) across a transmission 215 and an associated retransmission 230, the network entity 105-a may configure the UE 115-a, via the RRC message 205, to utilize a same control parameter 210 for the retransmission 230 as the transmission 215. For example, the network entity 105-a may output the transmission 215 according to a transmission parameter associated with a coding rate (MCS). Because of a rate matching procedure configured to receive a same quantity of bits in a retransmission as a transmission, the network entity 105-a may output a retransmission 230 using the same coding rate as the transmission 215. As the coding rate is the same between the transmission 215 and the retransmission 230, transmitting a dedicated DCI 225 indicating the coding rate is redundant. Therefore, the network entity 105-a may indicate the coding rate in the RRC message 205 at a time before the transmission 215. In some cases, the retransmission 230 may utilize a different modulation (e.g., quadrature phase-shift keying (QPSK), quadrature amplitude modulation (QAM), etc.).

In some implementations, the control parameters 210 may be indicated via ratios, differences, or both, between the transmission 215 and the retransmission 230. For example, a control parameter 210 for the retransmissions may be an example of a differential parameter that indicates a difference between a parameter of the transmission 215 and the retransmission 230. In some examples, a control parameter 210 may indicate to the UE 115-a to use a portion of a quantity of frequency resources used for the transmission 215. Additionally, the control parameter 210 may be an indication of a redundancy version, where the indication may be in the form of a modulo of a max redundancy version value, among other examples. Because the retransmissions 230 are relative to each transmission 215, by indicating the control parameters 210 for a retransmission 230 based on a ratio, difference, or both, between the retransmission 230 and the associated transmission 215, (e.g., rather than a specific value) the control parameters 210 may be relevant for multiple retransmissions 230.

In some examples, the control parameters 210 may include various indications to be used for multiple retransmissions 230. For example, the control parameters 210 may include an indication of a bandwidth or bandwidth group, a frequency allocation, whether a hopping pattern is enabled and a configured allocation offset, a redundancy version, an MCS, or any combination thereof. In some implementations, the bandwidth may be a bandwidth less than a bandwidth associated with the transmission 215. For example, a network entity 105-a may determine that a retransmission 230 may utilize a portion of a first bandwidth associated with a transmission 215. The network entity 105-a may output an RRC message 205 including a control parameter 210 that indicates a second bandwidth for receiving the retransmission 230 at a ratio of the first bandwidth associated with the transmission 215, thus reducing a quantity of power a UE 115-a may consume in processing the second bandwidth. In some cases, the UE 115-a may adjust a sampling rate associated with processing the retransmission 230 according to the second bandwidth.

Additionally, or alternatively, the frequency allocation may be an allocation of frequency resources less than a quantity of frequency resources associated with the transmission 215. For example, for any retransmission procedure associated with a HARQ process a portion of a transmission 215 (e.g., a quantity of code block groups) may pass a CRC check. Thus, a payload of a retransmission 230 associated with the transmission 215 may be decreased by the portion that passed. In some cases, the network entity 105-a may determine a proportional quantity of code block groups that the UE 115-a may fail to process (e.g., a quantity of code block groups the UE 115-a is likely to fail to process) and allocate a quantity of frequency resources for retransmissions 230 based on the likelihood of failure. The network entity 105-a may output an RRC message 205 including a control parameter 210 that indicates a first quantity of frequency resources for receiving the retransmission 230 at a difference from a second quantity of frequency resources associated with the transmission 215 (e.g., the parameter for the retransmission 230 is a differential value relative to the transmission 215), thus reducing a quantity of power a UE 115-a may consume in processing the first quantity of frequency resources (e.g., the larger payload). In some examples, the UE 115-a may reduce power consumption by being capable of adjusting components (e.g., DFE and other components) to receive the retransmission sooner. Thus, reducing an amount of time the UE 115-a may be monitoring larger frequency spectrum bands. In some cases, the network entity 105-a may utilize hybrid allocation signaling, in which an allocation most significant bit (MSB) may be configured (e.g., in the RRC message 205) and a least significant bit (LSB) may be signaled in a PDCCH (e.g., the DCI 225).

In some implementations, the network entity 105-a may optionally output a DCI 225 in addition to the RRC message 205. For example, the network entity 105-a may output the DCI 225 to configure the retransmission 230. In some cases, the DCI 225 may include a control parameter associated with the control parameters 210. The UE 115-a may determine to use the control parameters 210 and ignore the control parameter included in the DCI 225. In some cases, the DCI 225 may be a modified DCI 225 according to a modified format that excludes some control parameters (e.g., control parameters associated with control parameters 210). As such, the modified DCI 225 may include a reduced control payload, which may result in improved throughput (e.g., the UE 115-a may map more data instead of control), reduce power consumption, and provide a more efficient utilization of resources.

In some implementations, the network entity 105-a may output a control message (e.g., an RRC message 205) including control parameters 210 for uplink retransmissions. Similar to the examples provided herein associated with downlink retransmissions, the control parameters 210 for uplink retransmissions may indicate a ratio, a difference, or both between a first transmission and an associated retransmission, which may result in a reduced payload associated with a DCI 225, reduced consumption of power, and more efficient utilization of resources. For example, the UE 115-a may transmit a UCI 235 (e.g., including feedback associated with the transmission 215) and receive a modified DCI 225 in response to the UCI 235 according to a modified format that excludes control parameters associated with the control parameters 210 included in the RRC message 205. Alternatively, the network entity 105-a may determine to use the control parameters 210 and ignore associated parameters included in the DCI 225.

In some examples, the network entity 105-a may update the control parameters 210. For example, the network entity 105-a may output a second RRC message 205, a MAC-CE, or both, that include one or more control parameters 210.

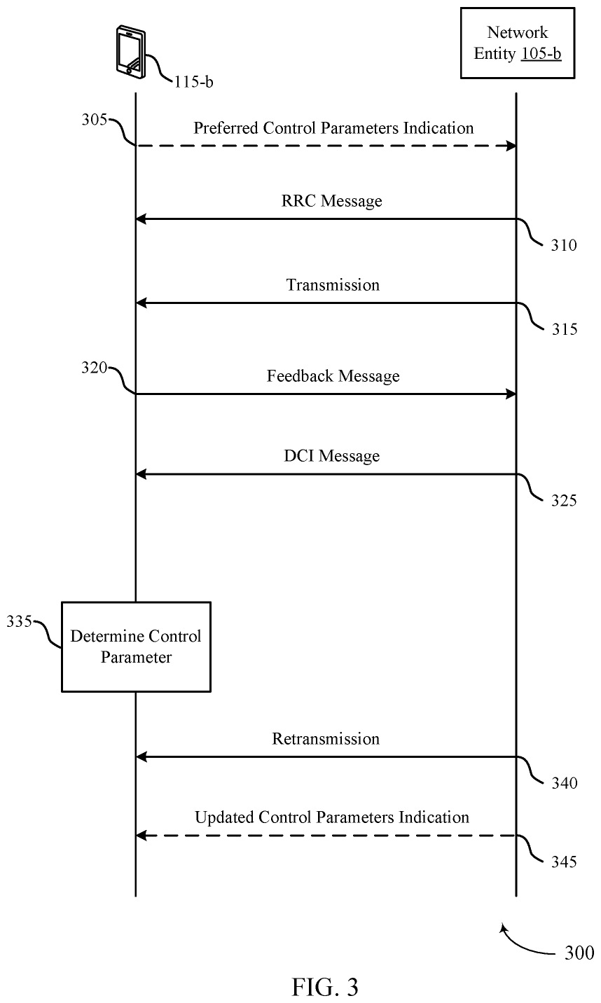

FIG. 3 illustrates an example of a process flow 300 that supports configure retransmission parameters in accordance with one or more aspects of the present disclosure. In some examples, the process flow 300 may implement or be implemented by aspects of the wireless communications systems 100 and 200 as described with reference to FIGS. 1 and 2, respectively. For example, the process flow 300 may be implemented by a network entity 105-b and a UE 115-b, which may be respective examples of network entities 105 and UEs 115 as described with reference to FIGS. 1 and 2, respectively. In the following description of the process flow 300, the operations between the network entity 105-b and the UE 115-b may be transmitted in a different order than the example order shown, or the operations performed by the network entity 105-b and the UE 115-b may be performed in different orders or at different times. Some operations may also be omitted from the process flow 300, and other operations may be added to the process flow 300.

At 305, the UE 115-b may optionally transmit an indication of one or more preferred control parameters. The preferred control parameters may be associated with one or more retransmissions that are a part of a HARQ process. In some cases, the UE 115-b may perform a connection establishment procedure and transmit the indication as part of the connection establishment procedure and before the UE 115-b receives a control message including control parameters associated with the one or more retransmissions. In some cases, the network entity 105-b may determine one or more control parameters based on the indication of preferred control parameters. For example, the network entity 105-b may use the preferred control parameters or ignore the preferred control parameters.

At 310, the network entity 105-b may output the control message. In some implementations the control message may be an RRC message or a MAC-CE message (e.g., as part of the connection establishment procedure) associated with retransmissions for feedback messages. The feedback messages, in some cases, being associated with HARQ messages and the retransmissions being downlink retransmissions. The control message may include a control parameter including an indication of a resource (e.g., a time, frequency, spatial, or other resource) used for the retransmissions. The resource may indicate a time resource (e.g., a slot) for the retransmissions. Additionally, or alternatively, the resource may be one or more frequency resources associated with a bandwidth, a bandwidth group, a bandwidth part, or any combination thereof, for the retransmissions. In some cases, the frequency resources may include a quantity of resources different than a quantity of resources for a first transmission associated with an instance of the feedback messages indicated by the control message. For example, the quantity of frequency resources for the retransmissions may be less than the quantity of resources for the transmissions (e.g., a ratio, a difference, or both, between the transmissions and the retransmissions).

In some implementations, the control message may include multiple control parameters for the retransmissions. For example, the multiple control parameters may include indications associated with the resources used for the retransmissions, whether a hopping pattern is enabled for the retransmissions, a redundancy version for the retransmissions, a frequency allocation for the retransmissions, a coding rate (MCS) for the retransmissions, or any combination thereof. In some cases, each of the indications may include a ratio, a difference, or both, between the transmissions and the retransmissions.

At 315, the network entity 105-b may output the first transmission. The UE 115-b may receive the first transmission and process the first transmission. In some cases, the UE 115-b may fail to receive the first transmission or fail to process all of the first transmission. In such cases, the UE 115-b may transmit, at 320, a feedback message that includes an indication of message failure (e.g., a NACK) as part of a feedback process (e.g., a HARQ process). The network entity 105-b may obtain the feedback message and determine to output one or more retransmissions associated with the feedback messages of the first transmission.

At 325, the network entity 105-b may output a DCI message (e.g., if HARQ retransmissions are used for downlink communications). In some cases, the network entity 105-b may output the DCI message to configure the UE 115-b for a first retransmission. In some implementations, the DCI message may indicate to the UE 115-b to adjust a sampling rate associated with processing the first retransmission. For example, the first retransmission may utilize less frequency resources (e.g., bandwidth) than the first transmission (e.g., a portion of code block groups associated with the first transmission may be retransmitted). The UE 115-b may determine to use the frequency resource (e.g., a portion of the resources associated with the first transmission) indicated in the RRC message for the first retransmission and adjust the sampling rate for the first retransmission based on determining that the DCI message is associated with the retransmission. In some cases, the DCI message may be a modified DCI message that excludes the multiple control parameters.

Additionally, or alternatively, the DCI message may include one or more second control parameters. For example, the DCI message may include the multiple control parameters. For example, the multiple control parameters may include indications associated with the resources used for the retransmissions, whether a hopping pattern is enabled for the retransmissions, a redundancy version for the retransmissions, a frequency allocation for the retransmissions, a coding rate (MCS) for the retransmissions, or any combination thereof. In some cases, each of the indications may include a ratio, a difference, or both, between the transmissions and the retransmissions. In some cases, the multiple control parameters of the DCI message may be the same as, different from, or any combination thereof, the multiple control parameters of the RRC message. In such examples, the UE 115-b may determine which parameter to use (e.g., the parameter from the RRC message or the parameter from the DCI) based on various factors. For example, UE 115-b may prioritize using parameters included in the RRC message over parameters included in the DCI, or vice versa.

Additionally, or alternatively, the UE 115-b may optionally transmit a DCI message associated with a physical uplink shared channel (PUSCH) (e.g., if HARQ retransmissions are used for uplink communications). For example, at 315, the UE 115-b may transmit the first transmission and at 320 the network entity 105-b may output the feedback message associated with the first transmission. The UE 115-b may determine to transmit one or more uplink retransmissions based on the feedback message. In some cases, the DCI message may be associated with a first retransmission for the first transmission. The DCI message may be a modified DCI message that excludes the multiple control parameters indicated by the RRC message (e.g., a DCI message with a reduced payload). Alternatively, the DCI message may include one or more of the multiple control parameters indicated by the RRC message. In such examples, the network entity 105-b may determine which parameter to use (e.g., the parameter from the RRC message or the parameter from the DCI) based on various factors. For example, the network entity 105-b may prioritize using parameters included in the RRC message over parameters included in the DCI, or vice versa.

At 335, the UE 115-b may determine one or more control parameters for the first retransmission. For example, the if the DCI message included one or more of the multiple control parameters of the RRC message, the UE 115-b may determine to use the multiple control parameters of the RRC message and ignore the associated control parameters from the DCI message. In some examples, if the DCI message is a modified DCI message that excludes the multiple control parameters, the UE 115-b may determine to use the multiple control parameters of the RRC message regardless of receiving the DCI message. In some implementations, if the first retransmission is an uplink retransmission, the network entity 105-b may determine to use the multiple control parameters of the RRC message and ignore the associated control parameters from the DCI message associated with the PUSCH.

At 340, the network entity 105-b may output the first retransmission. The UE 115-b may process the first retransmission associated with the feedback messages of the first transmission according to the configuration of the multiple control parameters of the RRC message. In some cases, the network entity 105-b and the UE 115-b may repeat outputting and receiving multiple transmissions and retransmissions based on the RRC message. At 345, the network entity 105-b may optionally output a second control message (e.g., a second RRC, a MAC-CE, etc.) to update one or more of the multiple control parameters for subsequent retransmissions.

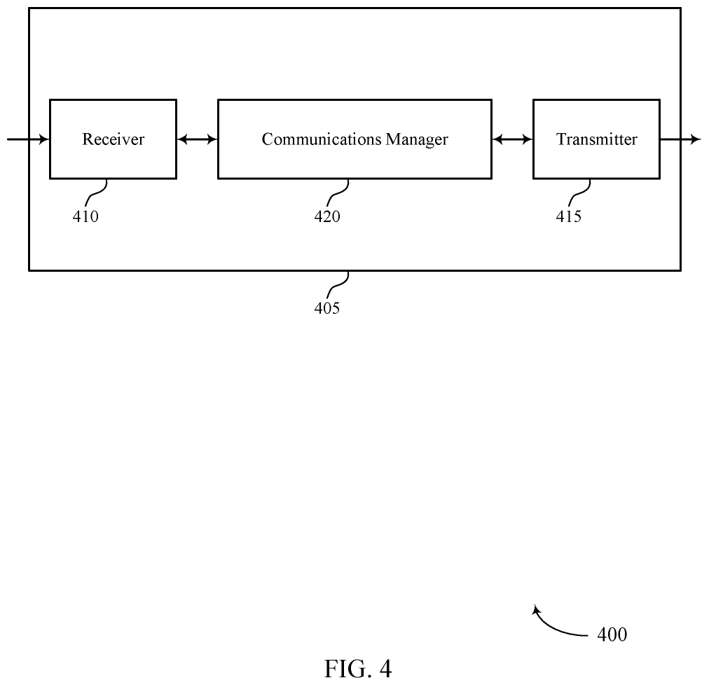

FIG. 4 shows a block diagram 400 of a device 405 that supports configure retransmission parameters in accordance with one or more aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to configure retransmission parameters). Information may be passed on to other components of the device 405. The receiver 410 may utilize a single antenna or a plurality antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to configure retransmission parameters). In some examples, the transmitter 415 may be co-located with a receiver 410 in a transceiver module. The transmitter 415 may utilize a single antenna or a plurality antennas.

The communications manager 420, the receiver 410, the transmitter 415, or various combinations thereof or various components thereof may be examples of means for performing various aspects of configure retransmission parameters as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and a memory coupled with the processor may be configured to perform one or more of the functions described herein (e.g., by executing, by the processor, instructions stored in the memory).

Additionally, or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communication at a UE in accordance with examples as disclosed herein. For example, the communications manager 420 may be configured as or otherwise support a means for receiving a control message including a control parameter associated with retransmissions for feedback messages, wherein the control parameter includes an indication of a resource used for the retransmissions. The communications manager 420 may be configured as or otherwise support a means for receiving a first transmission associated with an instance of the feedback messages indicated by the control message. The communications manager 420 may be configured as or otherwise support a means for transmitting a feedback message for the first transmission based at least in part on receiving the first transmission. The communications manager 420 may be configured as or otherwise support a means for receiving a first retransmission associated with the feedback messages of the first transmission based at least in part on transmitting the feedback message and the control parameter associated with the retransmissions.

By including or configuring the communications manager 420 in accordance with examples as described herein, the device 405 (e.g., a processor controlling or otherwise coupled with the receiver 410, the transmitter 415, the communications manager 420, or a combination thereof) may support techniques for reduced power consumption and more efficient utilization of communication resources.

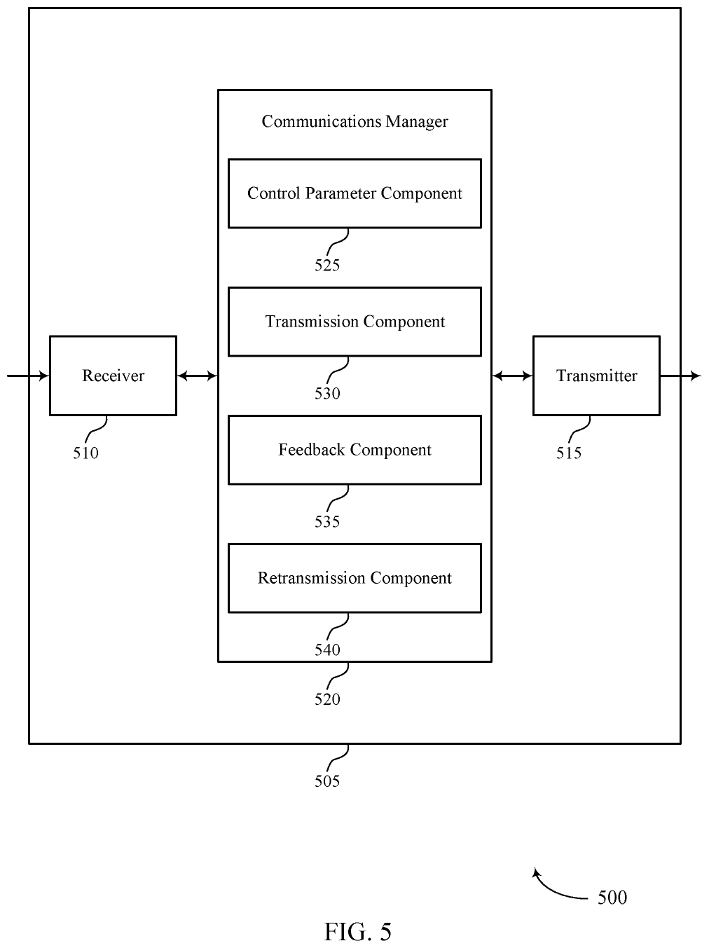

FIG. 5 shows a block diagram 500 of a device 505 that supports configure retransmission parameters in accordance with one or more aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to configure retransmission parameters). Information may be passed on to other components of the device 505. The receiver 510 may utilize a single antenna or a plurality antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to configure retransmission parameters). In some examples, the transmitter 515 may be co-located with a receiver 510 in a transceiver module. The transmitter 515 may utilize a single antenna or a plurality antennas.

The device 505, or various components thereof, may be an example of means for performing various aspects of configure retransmission parameters as described herein. For example, the communications manager 520 may include a control parameter component 525, a transmission component 530, a feedback component 535, a retransmission component 540, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE in accordance with examples as disclosed herein. The control parameter component 525 may be configured as or otherwise support a means for receiving a control message including a control parameter associated with retransmissions for feedback messages, wherein the control parameter includes an indication of a resource used for the retransmissions. The transmission component 530 may be configured as or otherwise support a means for receiving a first transmission associated with an instance of the feedback messages indicated by the control message. The feedback component 535 may be configured as or otherwise support a means for transmitting a feedback message for the first transmission based at least in part on receiving the first transmission. The retransmission component 540 may be configured as or otherwise support a means for receiving a first retransmission associated with the feedback messages of the first transmission based at least in part on transmitting the feedback message and the control parameter associated with the retransmissions.

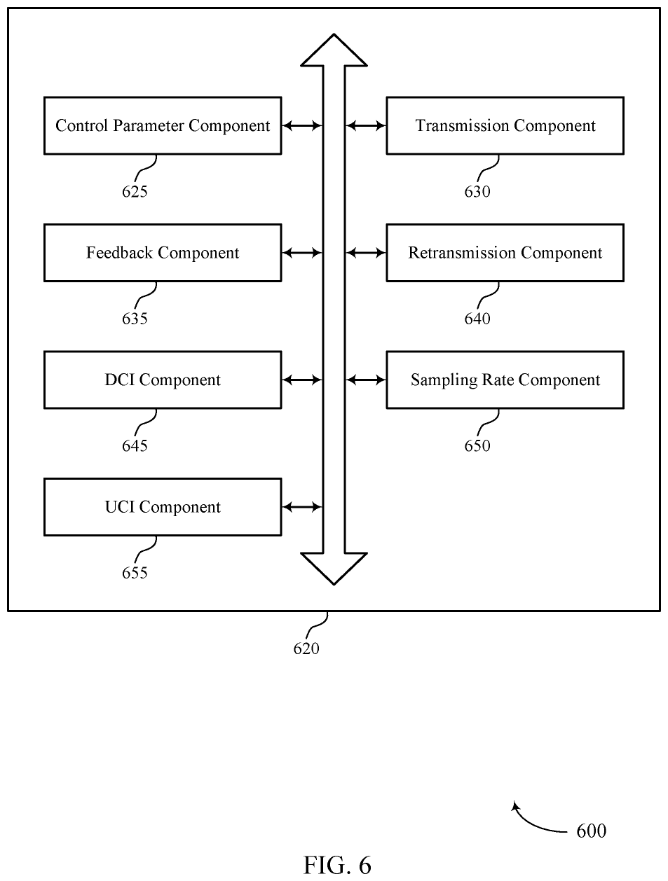

FIG. 6 shows a block diagram 600 of a communications manager 620 that supports configure retransmission parameters in accordance with one or more aspects of the present disclosure. The communications manager 620 may be an example of aspects of a communications manager 420, a communications manager 520, or both, as described herein. The communications manager 620, or various components thereof, may be an example of means for performing various aspects of configure retransmission parameters as described herein. For example, the communications manager 620 may include a control parameter component 625, a transmission component 630, a feedback component 635, a retransmission component 640, a DCI component 645, a sampling rate component 650, a UCI component 655, or any combination thereof. Each of these components may communicate, directly or indirectly, with one another (e.g., via one or more buses).

The communications manager 620 may support wireless communication at a UE in accordance with examples as disclosed herein. The control parameter component 625 may be configured as or otherwise support a means for receiving a control message including a control parameter associated with retransmissions for feedback messages, wherein the control parameter includes an indication of a resource used for the retransmissions. The transmission component 630 may be configured as or otherwise support a means for receiving a first transmission associated with an instance of the feedback messages indicated by the control message. The feedback component 635 may be configured as or otherwise support a means for transmitting a feedback message for the first transmission based at least in part on receiving the first transmission. The retransmission component 640 may be configured as or otherwise support a means for receiving a first retransmission associated with the feedback messages of the first transmission based at least in part on transmitting the feedback message and the control parameter associated with the retransmissions.

In some examples, the DCI component 645 may be configured as or otherwise support a means for receiving a DCI message associated with the first retransmission, the DCI message including a second control parameter. In some examples, the control parameter component 625 may be configured as or otherwise support a means for determining to use the control parameter from the control message and ignore the second control parameter from the DCI message based at least in part on receiving the DCI message, wherein the resource indicated in the control parameter is different than a second resource indicated in the second control parameter.

In some examples, the DCI component 645 may be configured as or otherwise support a means for receiving a DCI message associated with the first retransmission. In some examples, the sampling rate component 650 may be configured as or otherwise support a means for adjusting a sampling rate associated with the first retransmission based at least in part on the DCI message being associated with the first retransmission, wherein receiving the first retransmission is further based at least in part on adjusting the sampling rate.

In some examples, the control parameter component 625 may be configured as or otherwise support a means for transmitting a message indicating one or more preferred control parameters for the retransmissions, wherein the control parameter is based at least in part on the one or more preferred control parameters.

In some examples, to support receiving the control message, the control parameter component 625 may be configured as or otherwise support a means for receiving the control message that includes a plurality control parameters for the retransmissions, wherein the plurality control parameters includes the control parameter.

In some examples, the control parameter component 625 may be configured as or otherwise support a means for determining a second control parameter of the plurality control parameters including an indication of whether a hopping pattern is enabled for the retransmissions, a third control parameter of the plurality control parameters including an indication of a redundancy version for the retransmissions, a fourth control parameter of the plurality control parameters including an indication of frequency allocation used for the retransmissions, a fifth control parameter of the plurality control parameters including an indication of an MCS used for the retransmissions, or any combination thereof, wherein receiving the first retransmission is based at least in part on the determining.

In some examples, each indication of the plurality control parameters include a ratio, a difference, or both, between the first transmission and the retransmissions.

In some examples, the DCI component 645 may be configured as or otherwise support a means for receiving a DCI message associated with the first retransmission, wherein the DCI message excludes the control parameter.

In some examples, the UCI component 655 may be configured as or otherwise support a means for transmitting an UCI message associated with the first retransmission, wherein the UCI message excludes the control parameter.

In some examples, the UCI component 655 may be configured as or otherwise support a means for transmitting an UCI message associated with the first retransmission, the UCI message including a second control parameter. In some examples, the control parameter component 625 may be configured as or otherwise support a means for determining to use the control parameter from the control message and ignore the second control parameter from the UCI message, wherein the resource indicated in the control parameter is different than a frequency resource indicated in the second control parameter.

In some examples, the control parameter component 625 may be configured as or otherwise support a means for determining a time resource and a frequency resource used for the retransmissions based at least in part on the control parameter, wherein receiving the first retransmission is based at least in part on determining the time resource and the frequency resource.

In some examples, the control parameter component 625 may be configured as or otherwise support a means for receiving a second control message including an updated control parameter associated with the retransmissions for the feedback messages, wherein the second control message includes a RRC message or a MAC-CE message.

In some examples, the control message includes a RRC message is received as part of a connection establishment procedure.

In some examples, the feedback messages are associated with HARQ feedback. In some examples, the first retransmission is a downlink retransmission.

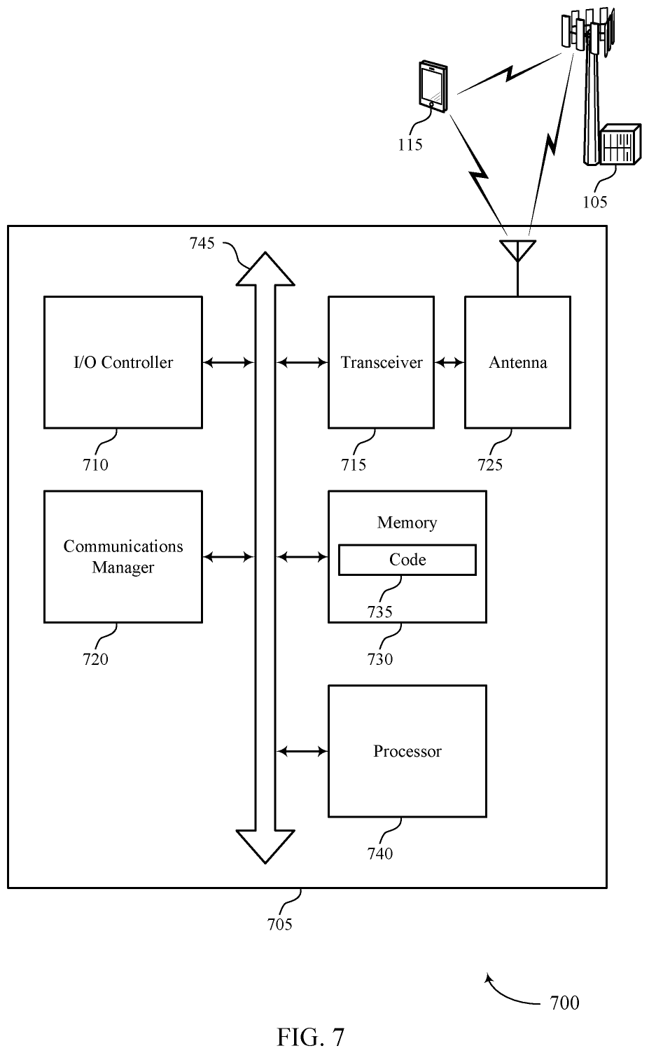

FIG. 7 shows a diagram of a system 700 including a device 705 that supports configure retransmission parameters in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting configure retransmission parameters). For example, the device 705 or a component of the device 705 may include a processor 740 and memory 730 coupled with or to the processor 740, the processor 740 and memory 730 configured to perform various functions described herein.

The communications manager 720 may support wireless communication at a UE in accordance with examples as disclosed herein. For example, the communications manager 720 may be configured as or otherwise support a means for receiving a control message including a control parameter associated with retransmissions for feedback messages, wherein the control parameter includes an indication of a resource used for the retransmissions. The communications manager 720 may be configured as or otherwise support a means for receiving a first transmission associated with an instance of the feedback messages indicated by the control message. The communications manager 720 may be configured as or otherwise support a means for transmitting a feedback message for the first transmission based at least in part on receiving the first transmission. The communications manager 720 may be configured as or otherwise support a means for receiving a first retransmission associated with the feedback messages of the first transmission based at least in part on transmitting the feedback message and the control parameter associated with the retransmissions.

By including or configuring the communications manager 720 in accordance with examples as described herein, the device 705 may support techniques for reduced power consumption and more efficient utilization of communication resources.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of configure retransmission parameters as described herein, or the processor 740 and the memory 730 may be otherwise configured to perform or support such operations.

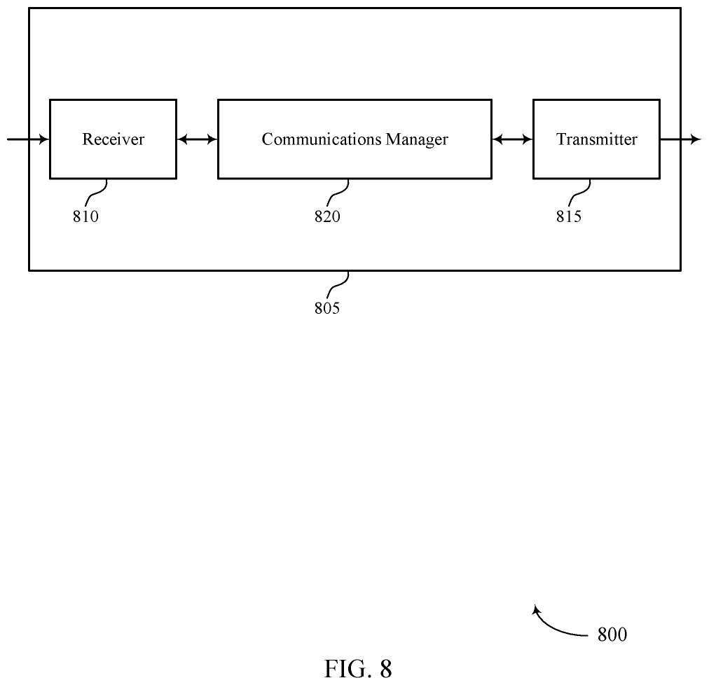

FIG. 8 shows a block diagram 800 of a device 805 that supports configure retransmission parameters in accordance with one or more aspects of the present disclosure. The device 805 may be an example of aspects of a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of configure retransmission parameters as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and a memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a network entity in accordance with examples as disclosed herein. For example, the communications manager 820 may be configured as or otherwise support a means for outputting a control message including a control parameter associated with retransmissions for feedback messages, wherein the control parameter includes an indication of a resource used for the retransmissions. The communications manager 820 may be configured as or otherwise support a means for outputting a first transmission associated with an instance of the feedback messages indicated by the control message. The communications manager 820 may be configured as or otherwise support a means for obtaining a feedback message for the first transmission based at least in part on outputting the first transmission. The communications manager 820 may be configured as or otherwise support a means for outputting a first retransmission associated with the feedback messages of the first transmission based at least in part on obtaining the feedback message and the control parameter associated with the retransmissions.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for reduced power consumption and more efficient utilization of communication resources.

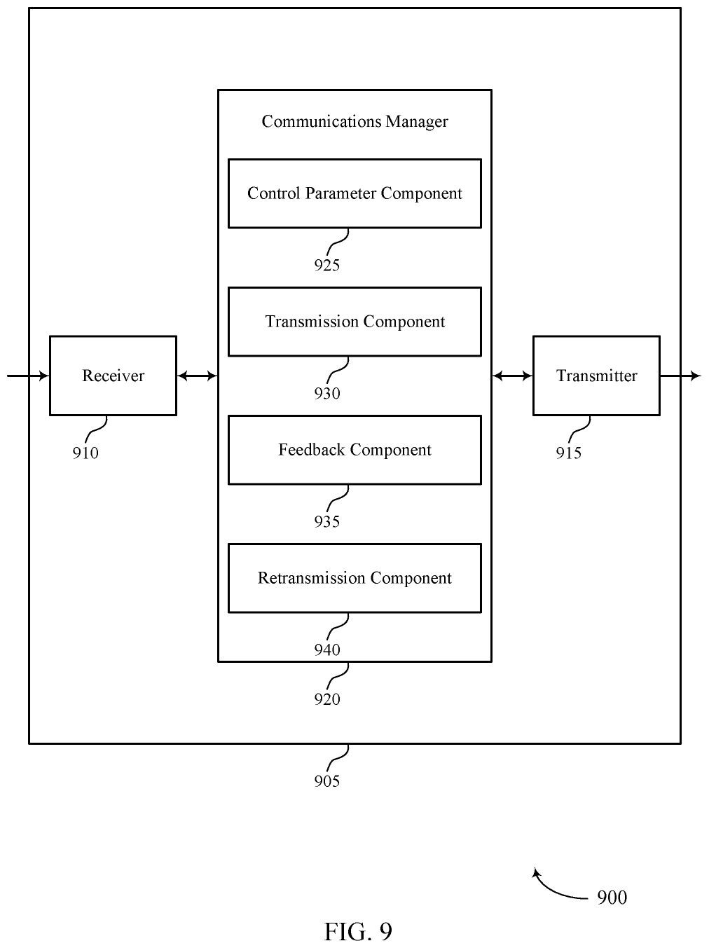

FIG. 9 shows a block diagram 900 of a device 905 that supports configure retransmission parameters in accordance with one or more aspects of the present disclosure. The device 905 may be an example of aspects of a device 805 or a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of configure retransmission parameters as described herein. For example, the communications manager 920 may include a control parameter component 925, a transmission component 930, a feedback component 935, a retransmission component 940, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a network entity in accordance with examples as disclosed herein. The control parameter component 925 may be configured as or otherwise support a means for outputting a control message including a control parameter associated with retransmissions for feedback messages, wherein the control parameter includes an indication of a resource used for the retransmissions. The transmission component 930 may be configured as or otherwise support a means for outputting a first transmission associated with an instance of the feedback messages indicated by the control message. The feedback component 935 may be configured as or otherwise support a means for obtaining a feedback message for the first transmission based at least in part on outputting the first transmission. The retransmission component 940 may be configured as or otherwise support a means for outputting a first retransmission associated with the feedback messages of the first transmission based at least in part on obtaining the feedback message and the control parameter associated with the retransmissions.

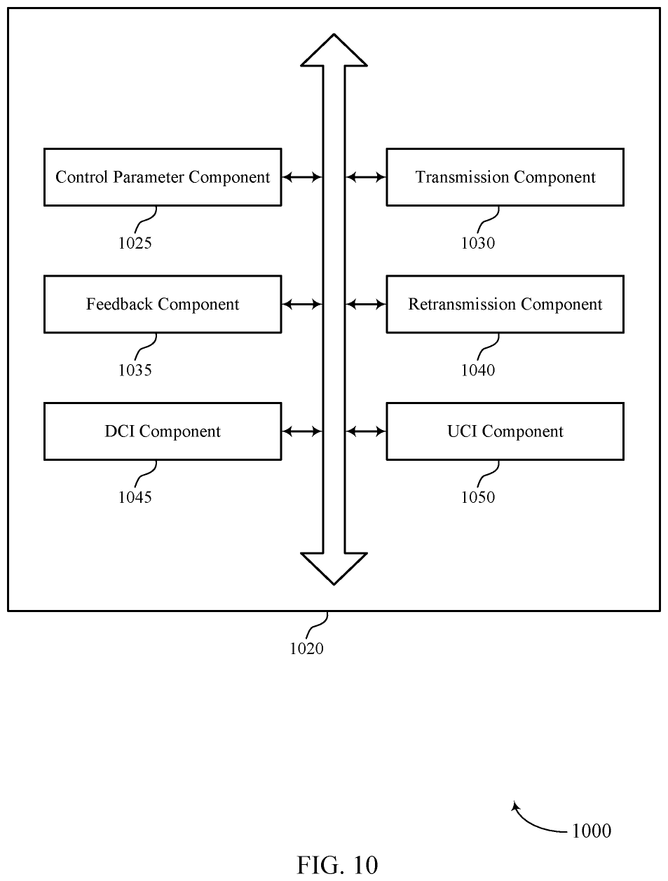

FIG. 10 shows a block diagram 1000 of a communications manager 1020 that supports configure retransmission parameters in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of configure retransmission parameters as described herein. For example, the communications manager 1020 may include a control parameter component 1025, a transmission component 1030, a feedback component 1035, a retransmission component 1040, a DCI component 1045, a UCI component 1050, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communication at a network entity in accordance with examples as disclosed herein. The control parameter component 1025 may be configured as or otherwise support a means for outputting a control message including a control parameter associated with retransmissions for feedback messages, wherein the control parameter includes an indication of a resource used for the retransmissions. The transmission component 1030 may be configured as or otherwise support a means for outputting a first transmission associated with an instance of the feedback messages indicated by the control message. The feedback component 1035 may be configured as or otherwise support a means for obtaining a feedback message for the first transmission based at least in part on outputting the first transmission. The retransmission component 1040 may be configured as or otherwise support a means for outputting a first retransmission associated with the feedback messages of the first transmission based at least in part on obtaining the feedback message and the control parameter associated with the retransmissions.

In some examples, the DCI component 1045 may be configured as or otherwise support a means for outputting a DCI message associated with the first retransmission, the DCI message including a second control parameter, wherein the resource indicated in the control parameter is different than a second resource indicated in the second control parameter.

In some examples, the DCI component 1045 may be configured as or otherwise support a means for outputting a DCI message associated with the first retransmission for adjusting a sampling rate associated with the first retransmission based at least in part on the DCI message being associated with the first retransmission, wherein outputting the first retransmission is further based at least in part on the adjusted sampling rate.

In some examples, the control parameter component 1025 may be configured as or otherwise support a means for obtaining a message indicating one or more preferred control parameters for the retransmissions, wherein the control parameter is based at least in part on the one or more preferred control parameters.

In some examples, to support outputting the control message, the control parameter component 1025 may be configured as or otherwise support a means for outputting the control message that includes a plurality control parameters for the retransmissions, wherein the plurality control parameters includes the control parameter.

In some examples, the control parameter component 1025 may be configured as or otherwise support a means for determining a second control parameter of the plurality control parameters including an indication of whether a hopping pattern is enabled for the retransmissions, a third control parameter of the plurality control parameters including an indication of a redundancy version for the retransmissions, a fourth control parameter of the plurality control parameters including an indication of frequency allocation used for the retransmissions, a fifth control parameter of the plurality control parameters including an indication of an MCS used for the retransmissions, or any combination thereof, wherein receiving the first retransmission is based at least in part on the determining.

In some examples, each indication of the plurality control parameters include a ratio, a difference, or both, between the first transmission and the retransmissions.

In some examples, the DCI component 1045 may be configured as or otherwise support a means for outputting a DCI message associated with the first retransmission, wherein the DCI message excludes the control parameter.

In some examples, the UCI component 1050 may be configured as or otherwise support a means for obtaining an UCI message associated with the first retransmission, wherein the UCI message excludes the control parameter.

In some examples, the UCI component 1050 may be configured as or otherwise support a means for obtaining an UCI message associated with the first retransmission, the UCI message including a second control parameter, wherein the resource indicated in the control parameter is different than a frequency resource indicated in the second control parameter.

In some examples, the control parameter component 1025 may be configured as or otherwise support a means for determining a time resource and a frequency resource used for the retransmissions based at least in part on the control parameter, wherein receiving the first retransmission is based at least in part on determining the time resource and the frequency resource.

In some examples, the control parameter component 1025 may be configured as or otherwise support a means for outputting a second control message including an updated control parameter associated with the retransmissions for the feedback messages, wherein the second control message includes a RRC message or a MAC-CE message.

In some examples, the control message is outputted as part of a connection establishment procedure.

In some examples, the feedback messages are associated with HARQ feedback. In some examples, the first retransmission is a downlink retransmission.

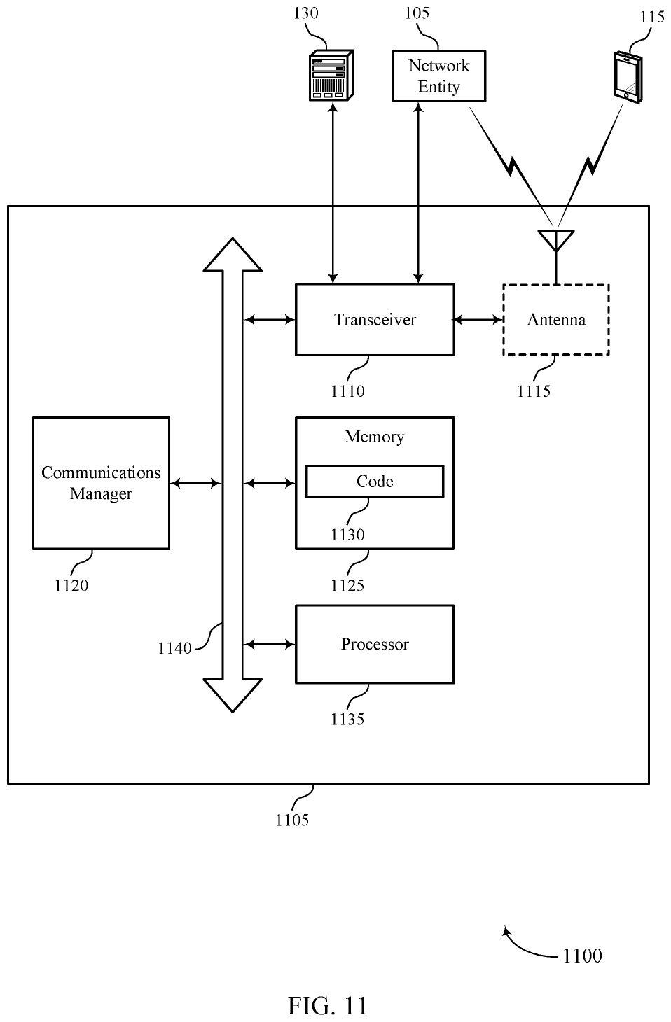

FIG. 11 shows a diagram of a system 1100 including a device 1105 that supports configure retransmission parameters in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. The transceiver 1110, or the transceiver 1110 and one or more antennas 1115 or wired interfaces, wherein applicable, may be an example of a transmitter 815, a transmitter 915, a receiver 810, a receiver 910, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting configure retransmission parameters). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., wherein the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communication at a network entity in accordance with examples as disclosed herein. For example, the communications manager 1120 may be configured as or otherwise support a means for outputting a control message including a control parameter associated with retransmissions for feedback messages, wherein the control parameter includes an indication of a resource used for the retransmissions. The communications manager 1120 may be configured as or otherwise support a means for outputting a first transmission associated with an instance of the feedback messages indicated by the control message. The communications manager 1120 may be configured as or otherwise support a means for obtaining a feedback message for the first transmission based at least in part on outputting the first transmission. The communications manager 1120 may be configured as or otherwise support a means for outputting a first retransmission associated with the feedback messages of the first transmission based at least in part on obtaining the feedback message and the control parameter associated with the retransmissions.

By including or configuring the communications manager 1120 in accordance with examples as described herein, the device 1105 may support techniques for reduced power consumption and more efficient utilization of communication resources.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., wherein applicable), or any combination thereof. Although the communications manager 1120 is illustrated as a separate component, in some examples, one or more functions described with reference to the communications manager 1120 may be supported by or performed by the processor 1135, the memory 1125, the code 1130, the transceiver 1110, or any combination thereof. For example, the code 1130 may include instructions executable by the processor 1135 to cause the device 1105 to perform various aspects of configure retransmission parameters as described herein, or the processor 1135 and the memory 1125 may be otherwise configured to perform or support such operations.

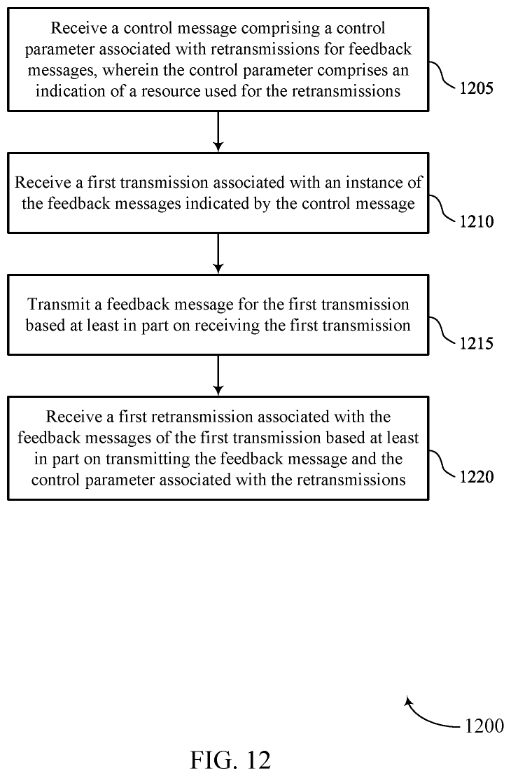

FIG. 12 shows a flowchart illustrating a method 1200 that supports configure retransmission parameters in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving a control message including a control parameter associated with retransmissions for feedback messages, wherein the control parameter includes an indication of a resource used for the retransmissions. The operations of 1205 may be performed in accordance with examples as disclosed herein. In some examples, aspects of the operations of 1205 may be performed by a control parameter component 625 as described with reference to FIG. 6.

At 1210, the method may include receiving a first transmission associated with an instance of the feedback messages indicated by the control message. The operations of 1210 may be performed in accordance with examples as disclosed herein. In some examples, aspects of the operations of 1210 may be performed by a transmission component 630 as described with reference to FIG. 6.

At 1215, the method may include transmitting a feedback message for the first transmission based at least in part on receiving the first transmission. The operations of 1215 may be performed in accordance with examples as disclosed herein. In some examples, aspects of the operations of 1215 may be performed by a feedback component 635 as described with reference to FIG. 6.

At 1220, the method may include receiving a first retransmission associated with the feedback messages of the first transmission based at least in part on transmitting the feedback message and the control parameter associated with the retransmissions. The operations of 1220 may be performed in accordance with examples as disclosed herein. In some examples, aspects of the operations of 1220 may be performed by a retransmission component 640 as described with reference to FIG. 6.

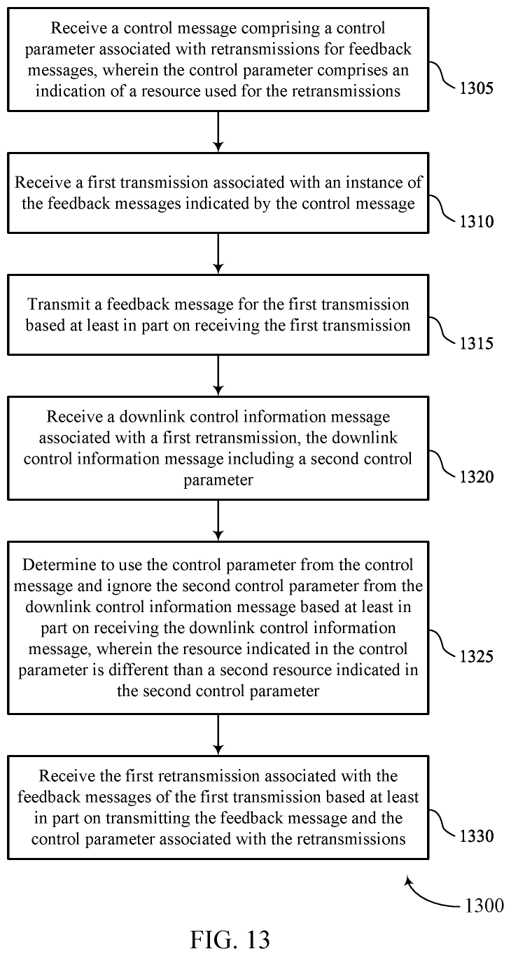

FIG. 13 shows a flowchart illustrating a method 1300 that supports configure retransmission parameters in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving a control message including a control parameter associated with retransmissions for feedback messages, wherein the control parameter includes an indication of a resource used for the retransmissions. The operations of 1305 may be performed in accordance with examples as disclosed herein. In some examples, aspects of the operations of 1305 may be performed by a control parameter component 625 as described with reference to FIG. 6.

At 1310, the method may include receiving a first transmission associated with an instance of the feedback messages indicated by the control message. The operations of 1310 may be performed in accordance with examples as disclosed herein. In some examples, aspects of the operations of 1310 may be performed by a transmission component 630 as described with reference to FIG. 6.

At 1315, the method may include transmitting a feedback message for the first transmission based at least in part on receiving the first transmission. The operations of 1315 may be performed in accordance with examples as disclosed herein. In some examples, aspects of the operations of 1315 may be performed by a feedback component 635 as described with reference to FIG. 6.

At 1320, the method may include receiving a DCI message associated with a first retransmission, the DCI message including a second control parameter. The operations of 1320 may be performed in accordance with examples as disclosed herein. In some examples, aspects of the operations of 1320 may be performed by a DCI component 645 as described with reference to FIG. 6.

At 1325, the method may include determining to use the control parameter from the control message and ignore the second control parameter from the DCI message based at least in part on receiving the DCI message, wherein the resource indicated in the control parameter is different than a second resource indicated in the second control parameter. The operations of 1325 may be performed in accordance with examples as disclosed herein. In some examples, aspects of the operations of 1325 may be performed by a control parameter component 625 as described with reference to FIG. 6.

At 1330, the method may include receiving the first retransmission associated with the feedback messages of the first transmission based at least in part on transmitting the feedback message and the control parameter associated with the retransmissions. The operations of 1330 may be performed in accordance with examples as disclosed herein. In some examples, aspects of the operations of 1330 may be performed by a retransmission component 640 as described with reference to FIG. 6.

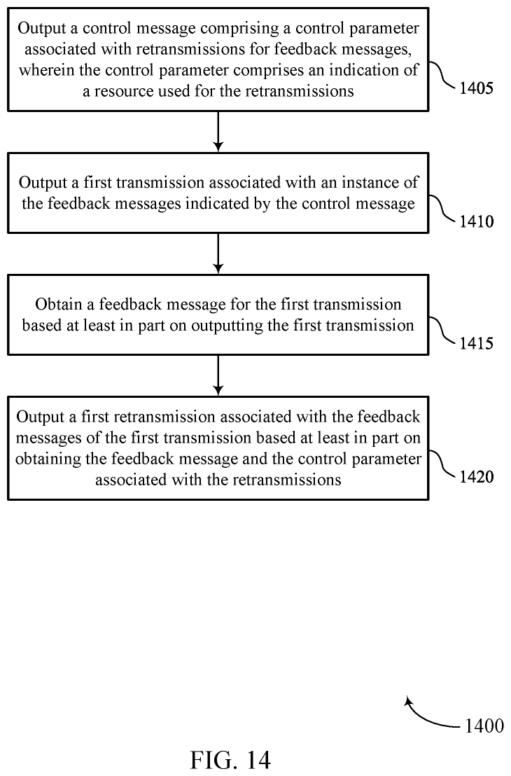

FIG. 14 shows a flowchart illustrating a method 1400 that supports configure retransmission parameters in accordance with one or more aspects of the present disclosure. The operations of the method 1400 may be implemented by a network entity or its components as described herein. For example, the operations of the method 1400 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1405, the method may include outputting a control message including a control parameter associated with retransmissions for feedback messages, wherein the control parameter includes an indication of a resource used for the retransmissions. The operations of 1405 may be performed in accordance with examples as disclosed herein. In some examples, aspects of the operations of 1405 may be performed by a control parameter component 1025 as described with reference to FIG. 10.

At 1410, the method may include outputting a first transmission associated with an instance of the feedback messages indicated by the control message. The operations of 1410 may be performed in accordance with examples as disclosed herein. In some examples, aspects of the operations of 1410 may be performed by a transmission component 1030 as described with reference to FIG. 10.

At 1415, the method may include obtaining a feedback message for the first transmission based at least in part on outputting the first transmission. The operations of 1415 may be performed in accordance with examples as disclosed herein. In some examples, aspects of the operations of 1415 may be performed by a feedback component 1035 as described with reference to FIG. 10.

At 1420, the method may include outputting a first retransmission associated with the feedback messages of the first transmission based at least in part on obtaining the feedback message and the control parameter associated with the retransmissions. The operations of 1420 may be performed in accordance with examples as disclosed herein. In some examples, aspects of the operations of 1420 may be performed by a retransmission component 1040 as described with reference to FIG. 10.

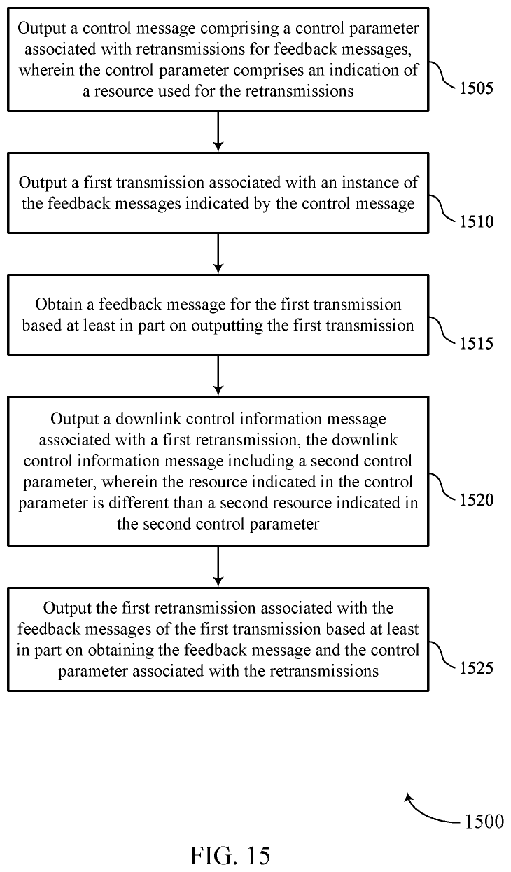

FIG. 15 shows a flowchart illustrating a method 1500 that supports configure retransmission parameters in accordance with one or more aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include outputting a control message including a control parameter associated with retransmissions for feedback messages, wherein the control parameter includes an indication of a resource used for the retransmissions. The operations of 1505 may be performed in accordance with examples as disclosed herein. In some examples, aspects of the operations of 1505 may be performed by a control parameter component 1025 as described with reference to FIG. 10.

At 1510, the method may include outputting a first transmission associated with an instance of the feedback messages indicated by the control message. The operations of 1510 may be performed in accordance with examples as disclosed herein. In some examples, aspects of the operations of 1510 may be performed by a transmission component 1030 as described with reference to FIG. 10.

At 1515, the method may include obtaining a feedback message for the first transmission based at least in part on outputting the first transmission. The operations of 1515 may be performed in accordance with examples as disclosed herein. In some examples, aspects of the operations of 1515 may be performed by a feedback component 1035 as described with reference to FIG. 10.

At 1520, the method may include outputting a DCI message associated with the first retransmission, the DCI message including a second control parameter, wherein the resource indicated in the control parameter is different than a second resource indicated in the second control parameter. The operations of 1520 may be performed in accordance with examples as disclosed herein. In some examples, aspects of the operations of 1520 may be performed by a DCI component 1045 as described with reference to FIG. 10.

At 1525, the method may include outputting a first retransmission associated with the feedback messages of the first transmission based at least in part on obtaining the feedback message and the control parameter associated with the retransmissions. The operations of 1525 may be performed in accordance with examples as disclosed herein. In some examples, aspects of the operations of 1525 may be performed by a retransmission component 1040 as described with reference to FIG. 10.

The following provides an overview of aspects of the present disclosure:

Aspect 1: A method for wireless communication at a UE, comprising: receiving a control message comprising a control parameter associated with retransmissions for feedback messages, wherein the control parameter comprises an indication of a resource used for the retransmissions; receiving a first transmission associated with an instance of the feedback messages indicated by the control message; transmitting a feedback message for the first transmission based at least in part on receiving the first transmission; and receiving a first retransmission associated with the feedback messages of the first transmission based at least in part on transmitting the feedback message and the control parameter associated with the retransmissions.

Aspect 2: The method of aspect 1, further comprising: receiving a DCI message associated with the first retransmission, the DCI message including a second control parameter; and determining to use the control parameter from the control message and ignore the second control parameter from the DCI message based at least in part on receiving the DCI message, wherein the resource indicated in the control parameter is different than a second resource indicated in the second control parameter.

Aspect 3: The method of any of aspects 1 through 2, further comprising: receiving a DCI message associated with the first retransmission; and adjusting a sampling rate associated with the first retransmission based at least in part on the DCI message being associated with the first retransmission, wherein receiving the first retransmission is further based at least in part on adjusting the sampling rate.

Aspect 4: The method of any of aspects 1 through 3, further comprising: transmitting a message indicating one or more preferred control parameters for the retransmissions, wherein the control parameter is based at least in part on the one or more preferred control parameters.

Aspect 5: The method of any of aspects 1 through 4, wherein receiving the control message further comprises: receiving the control message that includes a plurality of control parameters for the retransmissions, wherein the plurality of control parameters comprises the control parameter.

Aspect 6: The method of aspect 5, further comprising: determining a second control parameter of the plurality of control parameters comprising an indication of whether a hopping pattern is enabled for the retransmissions, a third control parameter of the plurality of control parameters comprising an indication of a redundancy version for the retransmissions, a fourth control parameter of the plurality of control parameters comprising an indication of frequency allocation used for the retransmissions, a fifth control parameter of the plurality of control parameters comprising an indication of a MCS used for the retransmissions, or any combination thereof, wherein receiving the first retransmission is based at least in part on the determining.

Aspect 7: The method of aspect 6, wherein each indication of the plurality of control parameters comprise a ratio, a difference, or both, between the first transmission and the retransmissions.

Aspect 8: The method of any of aspects 1 through 7, further comprising: receiving a DCI message associated with the first retransmission, wherein the DCI message excludes the control parameter.

Aspect 9: The method of any of aspects 1 through 8, further comprising: transmitting an UCI message associated with the first retransmission, wherein the UCI message excludes the control parameter.

Aspect 10: The method of any of aspects 1 through 9, further comprising: transmitting an UCI message associated with the first retransmission, the UCI message including a second control parameter; and determining to use the control parameter from the control message and ignore the second control parameter from the UCI message, wherein the resource indicated in the control parameter is different than a frequency resource indicated in the second control parameter.

Aspect 11: The method of any of aspects 1 through 10, further comprising: determining a time resource and a frequency resource used for the retransmissions based at least in part on the control parameter, wherein receiving the first retransmission is based at least in part on determining the time resource and the frequency resource.

Aspect 12: The method of any of aspects 1 through 11, further comprising: receiving a second control message comprising an updated control parameter associated with the retransmissions for the feedback messages, wherein the second control message comprises a RRC message or a MAC-CE message.

Aspect 13: The method of any of aspects 1 through 12, wherein the control message comprises a RRC message is received as part of a connection establishment procedure.

Aspect 14: The method of any of aspects 1 through 13, wherein the feedback messages are associated with HARQ feedback; and the first retransmission is a downlink retransmission.

Aspect 15: A method for wireless communication at a network entity, comprising: outputting a control message comprising a control parameter associated with retransmissions for feedback messages, wherein the control parameter comprises an indication of a resource used for the retransmissions; outputting a first transmission associated with an instance of the feedback messages indicated by the control message; obtaining a feedback message for the first transmission based at least in part on outputting the first transmission; and outputting a first retransmission associated with the feedback messages of the first transmission based at least in part on obtaining the feedback message and the control parameter associated with the retransmissions.

Aspect 16: The method of aspect 15, further comprising: outputting a DCI message associated with the first retransmission, the DCI message including a second control parameter, wherein the resource indicated in the control parameter is different than a second resource indicated in the second control parameter.

Aspect 17: The method of any of aspects 15 through 16, further comprising: outputting a DCI message associated with the first retransmission for adjusting a sampling rate associated with the first retransmission based at least in part on the DCI message being associated with the first retransmission, wherein outputting the first retransmission is further based at least in part on the adjusted sampling rate.

Aspect 18: The method of any of aspects 15 through 17, further comprising: obtaining a message indicating one or more preferred control parameters for the retransmissions, wherein the control parameter is based at least in part on the one or more preferred control parameters.

Aspect 19: The method of any of aspects 15 through 18, wherein outputting the control message further comprises: outputting the control message that includes a plurality of control parameters for the retransmissions, wherein the plurality of control parameters comprises the control parameter.

Aspect 20: The method of aspect 19, further comprising: determining a second control parameter of the plurality of control parameters comprising an indication of whether a hopping pattern is enabled for the retransmissions, a third control parameter of the plurality of control parameters comprising an indication of a redundancy version for the retransmissions, a fourth control parameter of the plurality of control parameters comprising an indication of frequency allocation used for the retransmissions, a fifth control parameter of the plurality of control parameters comprising an indication of a MCS used for the retransmissions, or any combination thereof, wherein receiving the first retransmission is based at least in part on the determining.

Aspect 21: The method of aspect 20, wherein each indication of the plurality of control parameters comprise a ratio, a difference, or both, between the first transmission and the retransmissions.

Aspect 22: The method of any of aspects 15 through 21, further comprising: outputting a DCI message associated with the first retransmission, wherein the DCI message excludes the control parameter.

Aspect 23: The method of any of aspects 15 through 22, further comprising: obtaining an UCI message associated with the first retransmission, wherein the UCI message excludes the control parameter.

Aspect 24: The method of any of aspects 15 through 23, further comprising: obtaining an UCI message associated with the first retransmission, the UCI message including a second control parameter, wherein the resource indicated in the control parameter is different than a frequency resource indicated in the second control parameter.

Aspect 25: The method of any of aspects 15 through 24, further comprising: determining a time resource and a frequency resource used for the retransmissions based at least in part on the control parameter, wherein receiving the first retransmission is based at least in part on determining the time resource and the frequency resource.

Aspect 26: The method of any of aspects 15 through 25, further comprising: outputting a second control message comprising an updated control parameter associated with the retransmissions for the feedback messages, wherein the second control message comprises a RRC message or a MAC-CE message.

Aspect 27: The method of any of aspects 15 through 26, wherein the control message is outputted as part of a connection establishment procedure.

Aspect 28: The method of any of aspects 15 through 27, wherein the feedback messages are associated with HARQ feedback; and the first retransmission is a downlink retransmission.

Aspect 29: An apparatus for wireless communication at a UE, comprising a processor; memory coupled with the processor; and instructions stored in the memory and executable by the processor to cause the apparatus to perform a method of any of aspects 1 through 14.

Aspect 30: An apparatus for wireless communication at a UE, comprising at least one means for performing a method of any of aspects 1 through 14.

Aspect 31: A non-transitory computer-readable medium storing code for wireless communication at a UE, the code comprising instructions executable by a processor to perform a method of any of aspects 1 through 14.

Aspect 32: An apparatus for wireless communication at a network entity, comprising a processor; memory coupled with the processor; and instructions stored in the memory and executable by the processor to cause the apparatus to perform a method of any of aspects 15 through 28.

Aspect 33: An apparatus for wireless communication at a network entity, comprising at least one means for performing a method of any of aspects 15 through 28.

Aspect 34: A non-transitory computer-readable medium storing code for wireless communication at a network entity, the code comprising instructions executable by a processor to perform a method of any of aspects 15 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor;
a memory coupled with the processor; and
instructions stored in the memory and executable by the processor to cause the apparatus to:
receive a control message comprising a control parameter associated with retransmissions for feedback messages, wherein the control parameter comprises an indication of a resource used for the retransmissions;
receive a first transmission associated with an instance of the feedback messages indicated by the control message;
transmit a feedback message for the first transmission based at least in part on receiving the first transmission; and
receive a first retransmission associated with the feedback messages of the first transmission based at least in part on transmitting the feedback message and the control parameter associated with the retransmissions.

2. The apparatus of claim 1, wherein the instructions are further executable by the processor to cause the apparatus to:
receive a downlink control information message associated with the first retransmission, the downlink control information message including a second control parameter; and
determine to use the control parameter from the control message and ignore the second control parameter from the downlink control information message based at least in part on receiving the downlink control information message, wherein the resource indicated in the control parameter is different than a second resource indicated in the second control parameter.

3. The apparatus of claim 1, wherein the instructions are further executable by the processor to cause the apparatus to:
receive a downlink control information message associated with the first retransmission; and
adjust a sampling rate associated with the first retransmission based at least in part on the downlink control information message being associated with the first retransmission, wherein receiving the first retransmission is further based at least in part on adjusting the sampling rate.

4. The apparatus of claim 1, wherein the instructions are further executable by the processor to cause the apparatus to:
transmit a message indicating one or more preferred control parameters for the retransmissions, wherein the control parameter is based at least in part on the one or more preferred control parameters.

5. The apparatus of claim 1, wherein the instructions to receive the control message are further executable by the processor to cause the apparatus to:
receive the control message that includes a plurality of control parameters for the retransmissions, wherein the plurality of control parameters comprises the control parameter.

6. The apparatus of claim 5, wherein the instructions are further executable by the processor to cause the apparatus to:
determine a second control parameter of the plurality of control parameters comprising an indication of whether a hopping pattern is enabled for the retransmissions, a third control parameter of the plurality of control parameters comprising an indication of a redundancy version for the retransmissions, a fourth control parameter of the plurality of control parameters comprising an indication of frequency allocation used for the retransmissions, a fifth control parameter of the plurality of control parameters comprising an indication of a modulation and coding scheme used for the retransmissions, or any combination thereof, wherein receiving the first retransmission is based at least in part on the determining.

7. The apparatus of claim 6, wherein each indication of the plurality of control parameters comprise a ratio, a difference, or both, between the first transmission and the retransmissions.

8. The apparatus of claim 1, wherein the instructions are further executable by the processor to cause the apparatus to:
receive a downlink control information message associated with the first retransmission, wherein the downlink control information message excludes the control parameter.

9. The apparatus of claim 1, wherein the instructions are further executable by the processor to cause the apparatus to:
transmit an uplink control information message associated with the first retransmission, wherein the uplink control information message excludes the control parameter.

10. The apparatus of claim 1, wherein the instructions are further executable by the processor to cause the apparatus to:
transmit an uplink control information message associated with the first retransmission, the uplink control information message including a second control parameter; and
determine to use the control parameter from the control message and ignore the second control parameter from the uplink control information message, wherein the resource indicated in the control parameter is different than a frequency resource indicated in the second control parameter.

11. The apparatus of claim 1, wherein the instructions are further executable by the processor to cause the apparatus to:
determine a time resource and a frequency resource used for the retransmissions based at least in part on the control parameter, wherein receiving the first retransmission is based at least in part on determining the time resource and the frequency resource.

12. The apparatus of claim 1, wherein the instructions are further executable by the processor to cause the apparatus to:
receive a second control message comprising an updated control parameter associated with the retransmissions for the feedback messages, wherein the second control message comprises a radio resource control message or a medium access control-control element message.

13. The apparatus of claim 1, wherein the control message comprises a radio resource control message is received as part of a connection establishment procedure.

14. The apparatus of claim 1, wherein:
the feedback messages are associated with hybrid automatic repeat request feedback; and
the first retransmission is a downlink retransmission.

15. An apparatus for wireless communication at a network entity, comprising:
a processor;
a memory coupled with the processor; and
instructions stored in the memory and executable by the processor to cause the apparatus to:
output a control message comprising a control parameter associated with retransmissions for feedback messages, wherein the control parameter comprises an indication of a resource used for the retransmissions;
output a first transmission associated with an instance of the feedback messages indicated by the control message;
obtain a feedback message for the first transmission based at least in part on outputting the first transmission; and
output a first retransmission associated with the feedback messages of the first transmission based at least in part on obtaining the feedback message and the control parameter associated with the retransmissions.

16. The apparatus of claim 15, wherein the instructions are further executable by the processor to cause the apparatus to:
output a downlink control information message associated with the first retransmission, the downlink control information message including a second control parameter, wherein the resource indicated in the control parameter is different than a second resource indicated in the second control parameter.

17. The apparatus of claim 15, wherein the instructions are further executable by the processor to cause the apparatus to:
output a downlink control information message associated with the first retransmission for adjusting a sampling rate associated with the first retransmission based at least in part on the downlink control information message being associated with the first retransmission, wherein outputting the first retransmission is further based at least in part on the adjusted sampling rate.

18. The apparatus of claim 15, wherein the instructions are further executable by the processor to cause the apparatus to:
obtain a message indicating one or more preferred control parameters for the retransmissions, wherein the control parameter is based at least in part on the one or more preferred control parameters.

19. The apparatus of claim 15, wherein the instructions to output the control message are further executable by the processor to cause the apparatus to:
output the control message that includes a plurality of control parameters for the retransmissions, wherein the plurality of control parameters comprises the control parameter.

20. The apparatus of claim 19, wherein the instructions are further executable by the processor to cause the apparatus to:
determine a second control parameter of the plurality of control parameters comprising an indication of whether a hopping pattern is enabled for the retransmissions, a third control parameter of the plurality of control parameters comprising an indication of a redundancy version for the retransmissions, a fourth control parameter of the plurality of control parameters comprising an indication of frequency allocation used for the retransmissions, a fifth control parameter of the plurality of control parameters comprising an indication of a modulation and coding scheme used for the retransmissions, or any combination thereof, wherein receiving the first retransmission is based at least in part on the determining.

21. The apparatus of claim 20, wherein each indication of the plurality of control parameters comprise a ratio, a difference, or both, between the first transmission and the retransmissions.

22. The apparatus of claim 15, wherein the instructions are further executable by the processor to cause the apparatus to:
output a downlink control information message associated with the first retransmission, wherein the downlink control information message excludes the control parameter.

23. The apparatus of claim 15, wherein the instructions are further executable by the processor to cause the apparatus to:
obtain an uplink control information message associated with the first retransmission, wherein the uplink control information message excludes the control parameter.

24. The apparatus of claim 15, wherein the instructions are further executable by the processor to cause the apparatus to:
obtain an uplink control information message associated with the first retransmission, the uplink control information message including a second control parameter, wherein the resource indicated in the control parameter is different than a frequency resource indicated in the second control parameter.

25. The apparatus of claim 15, wherein the instructions are further executable by the processor to cause the apparatus to:
determine a time resource and a frequency resource used for the retransmissions based at least in part on the control parameter, wherein receiving the first retransmission is based at least in part on determining the time resource and the frequency resource.

26. The apparatus of claim 15, wherein the instructions are further executable by the processor to cause the apparatus to:
output a second control message comprising an updated control parameter associated with the retransmissions for the feedback messages, wherein the second control message comprises a radio resource control message or a medium access control-control element message.

27. The apparatus of claim 15, wherein the control message is outputted as part of a connection establishment procedure.

28. The apparatus of claim 15, wherein:
the feedback messages are associated with hybrid automatic repeat request feedback; and
the first retransmission is a downlink retransmission.

29. A method for wireless communication at a user equipment (UE), comprising:
receiving a control message comprising a control parameter associated with retransmissions for feedback messages, wherein the control parameter comprises an indication of a resource used for the retransmissions;
receiving a first transmission associated with an instance of the feedback messages indicated by the control message;
transmitting a feedback message for the first transmission based at least in part on receiving the first transmission; and
receiving a first retransmission associated with the feedback messages of the first transmission based at least in part on transmitting the feedback message and the control parameter associated with the retransmissions.

30. A method for wireless communication at a network entity, comprising:
outputting a control message comprising a control parameter associated with retransmissions for feedback messages, wherein the control parameter comprises an indication of a resource used for the retransmissions;
outputting a first transmission associated with an instance of the feedback messages indicated by the control message;
obtaining a feedback message for the first transmission based at least in part on outputting the first transmission; and
outputting a first retransmission associated with the feedback messages of the first transmission based at least in part on obtaining the feedback message and the control parameter associated with the retransmissions.
